(19) United States
(12) Patent Application Publication
(10) Pub. No.: US 2016/0169442 A1
(43) Pub. Date: Jun. 16, 2016

(54) SUPPORT ASSEMBLY FOR LEVELING A SURFACE

(71) Applicant: Keri J. Storjohann, Johnston, IA (US)

(72) Inventor: Keri J. Storjohann, Johnston, IA (US)

(21) Appl. No.: 14/970,908

(22) Filed: Dec. 16, 2015

Related U.S. Application Data
(60) Provisional application No. 62/092,626, filed on Dec. 16, 2014.

(51) Int. Cl. F16M 11/24; F16M 11/00

(52) U.S. Cl. CPC F16M 11/24; F16M 11/00; F16M 2200/08

(57) ABSTRACT

A support assembly includes a base having a plurality of slots. Removably received within the slots is a stand having a plurality of legs, a platform, and a support member. The support member has a threaded bore that receives a threaded shaft. Mounted to the threaded shaft is a material holding member such as a yoke.

### CROSS-REFERENCE TO RELATED APPLICATIONS

This application claims priority to Provisional Application U.S. Ser. No. 62/092,626 filed on Dec. 16, 2014, which is herein incorporated by reference in its entirety.

### BACKGROUND OF THE INVENTION

This invention is directed to a support assembly for establishing a level and/or flat surface or structural elements for construction such as roadways, driveways, sidewalks, patios, bridges, decks, elevated floors, basements, parking lots, feed lots, building floors, roofs, reinforcing mats, mesh, level subgrade, concrete overlays, sloped slabs and the like. More particularly, this invention is directed to a support system that maintains the finished elevation of a surface, slabs, floors and structural elements.

Leveling tools and guides are known in the art. Typically a stake or post is driven into the ground with a marker indicating a desired height of a finished surface. Sometimes, to insulate the finished surface a layer of plastic or other material is laid on the ground. While insulation is provided the posts are driven through the plastic layer or membrane which compromises the insulation and leads to moisture and/or gas leakage.

Additionally, current posts are not adjustable and must be placed within the ground at depths that result in level guidance. Currently, to adjust the height requires lifting the post from the ground or pressing the post deeper, which results in difficulties keeping the posts in place and along the desired path. Therefore, a need exists in the art for a device that addresses these deficiencies.

An objective of the present invention is to provide a support assembly that reduces moisture and/or gas leakage on a membrane.

Another objective of the present invention is to provide a support assembly that can be used on wood or metal elevated floors.

Another objective of the present invention is to provide a support assembly that is adjustable.

These and other objectives will be apparent to those skilled in the art based upon the following written description, drawings and claims.

### SUMMARY OF THE INVENTION

A support assembly includes a base having a plurality of slots. Removably received within the slots is a stand having a plurality of legs, a platform, and a support member. The support member has a threaded bore that receives a threaded shaft. Mounted to the threaded shaft is a material holding member such as a yoke, pipe or rebar. The stand and base can be used on vapor barrier and a variety of surfaces. However, the stand can be used alone on wood or metal elevated floors. The base can also accept other stands for different uses besides the yoke, such as a support for rebar, dowels, and the like.

### BRIEF DESCRIPTION OF THE FIGURES

FIG. 1 is a perspective view of a disassembled support assembly.

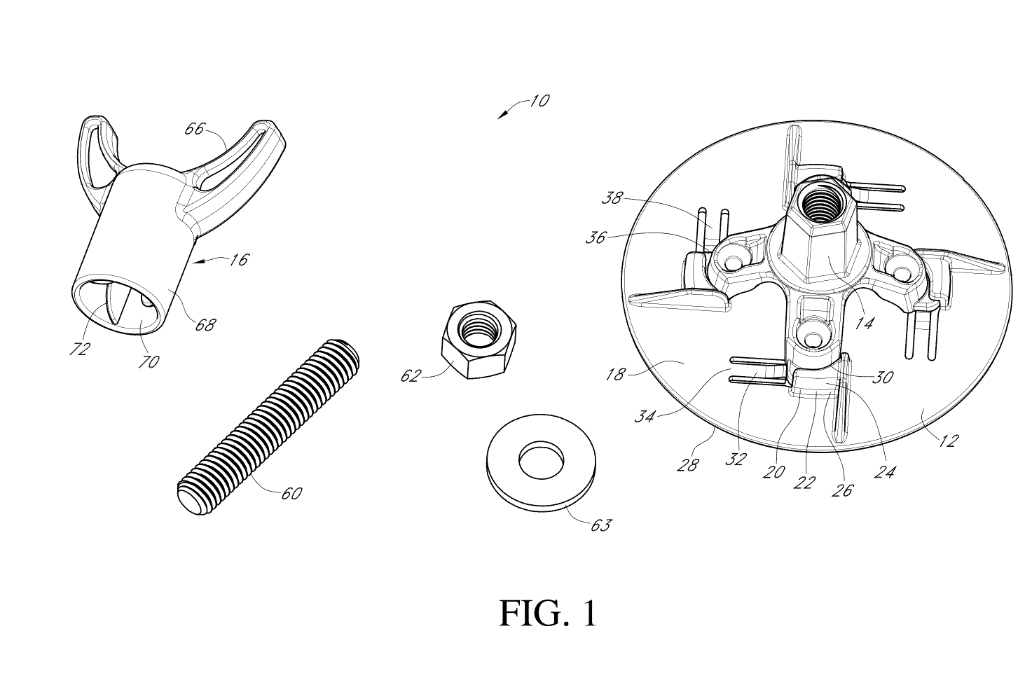

FIG. 2 is a perspective view of a support assembly;

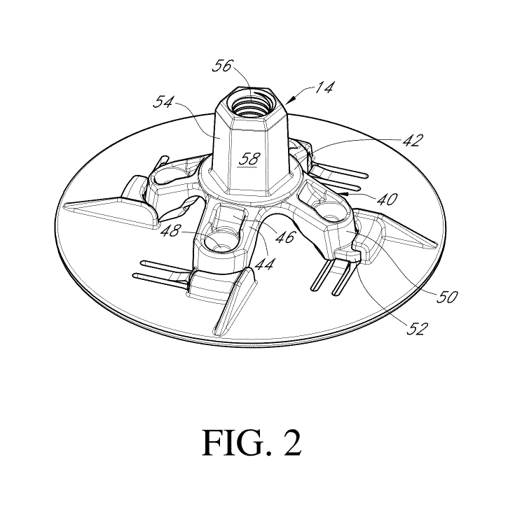

FIG. 3 is a bottom perspective view of a base for a support assembly;

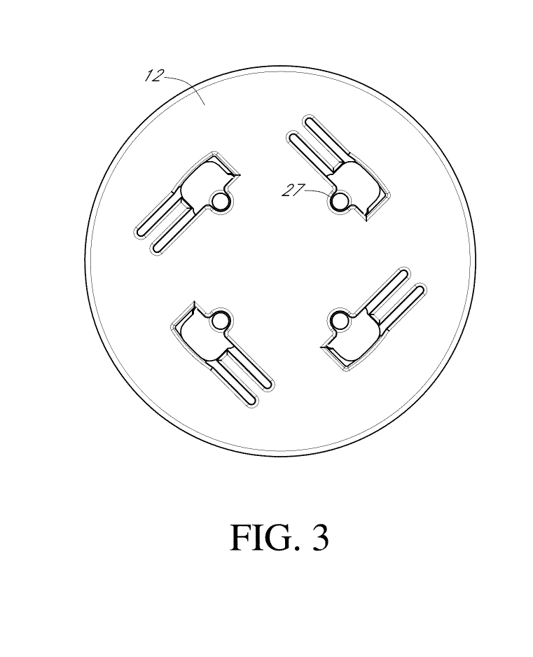

FIG. 4 is a perspective view of a support assembly; and

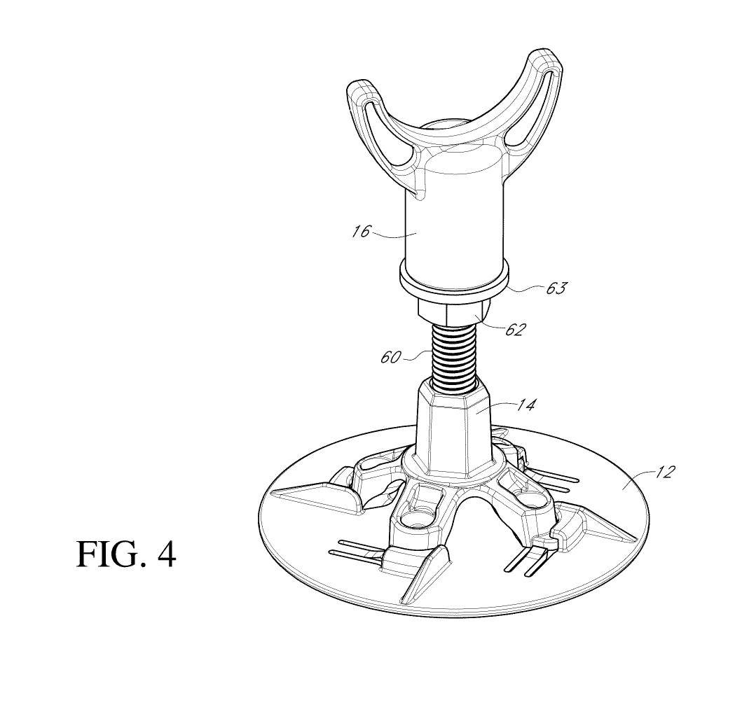

FIG. 5 is a plan view of a bottom of a base for a support assembly.

### DESCRIPTION OF THE PREFERRED EMBODIMENTS

Referring to the figures, a support assembly 10 has a base 12, a stand 14, and a yoke 16. The base 12, stand 14, and yoke 16 are separate pieces that can be used with or without one another. The base 12 is of any size and shape and as shown in the drawings, by example only, is circular. Extending upwardly from a top surface 18 of the base 12, are a plurality of slots 20. The slots 20 have an outer wall 22, a top wall 24, an end wall 26, and an open bottom 25 having a partially arcuate section 27. The end wall preferably extends from the raised slot 20 to an outer periphery 28 of the base 12. The top wall 24 has an arcuate inner edge 30.

Aligned with the raised slot 20 and generally perpendicular to the end walls 26, are a plurality of flexible prongs 32 that are cut out of the base 12. The prongs 32 have a first end 34 that is part of the base 12, and a second end 36 that is free from the base 12. As the prong 32 extends from the first end 34 to the second end 36, the top surface 38 of the prong 32 tapers upwardly such that a portion of the second end 36 dwells in a horizontal plane above a horizontal plane of the top surface 18 of the base 12.

Releasably connected to the base 12 is the stand 14. The stand 14 in one example, has a plurality of legs 40 that extend outwardly and downwardly from a platform 42. The top surface 44 of the legs have grooves 46 that terminate in openings 48 that align with the arcuate section 27 of the slots 20 when in a locked position. Extending outwardly from an end 50 of the legs 40 are flanges 52. The flanges 52 are formed to be received within slots 20. Alternatively, the stand 14 may not have legs.

Extending upwardly from platform 42 is a support member 54. Preferably, the support member 54 has a threaded bore 56 and a plurality of flat outer surfaces 58. Received within the threaded bore 56 is a threaded shaft 60 wherein a nut 62 and washer 63 can be attached to the shaft 60. In an alternative embodiment no nut 62 or washer 63 is used. Also, the support member 54 may have a notched or a smooth bore.

Removably attached to the support member 54 or to the threaded shaft 60 is a yoke 16. The yoke 16 has a cradle 66 and a support body 68 with a hollow interior 70. The hollow interior 70 has a plurality of flexible connection members 72 such as fins that extend from an interior sidewall of the support body 68 inwardly. In this manner, the flexible connection members 72 can flex or bend to accommodate different size mounting structures such as support member 54 or threaded shaft 60. Alternatively, the top of the support member 54 is formed as a rebar support, pipes support pre-cast wire chair, post tension chair, mesh chair or the like. Also, the legs 40, platform 42, and/or support member 54 have additional strengthening material added.

In operation, stand 14 is connected to base 12 by placing stand 14 on the top surface 18 of the base 12 and the stand 14 is rotated in relation to the base 12. When rotated, flanges 52 engage the top surface 38 of the prong 32 which deflects the prong 32 downward so that flanges 52 may rotate and slide into slots 20. As the flanges 52 clear the second end 36 of the prongs 32, the prongs 32 return to their normal position such that the second end 36 of the prong 32 engages flange 52 locking the flange 52 within slot 20. To release the stand 14 from the base 12, the prongs are pressed downward such that end 36 no longer engages flange 52 and the stand 14 is rotated in the opposite direction.

The stand 14 and/or base 12 is taped or glued to a surface or alternatively the stand 14 is screwed or nailed into a surface such as a metal or wood decking by inserting screws or nails (not shown) in openings 48 in the legs 40. To align multiple stands 14 by fitting a bar such as rebar through the space between the stand 14 and the base 12 or surface.

The yoke 64 is placed over support member 54 which preferably positions the base of the cradle 66 at 2.5 inches from the surface.

Alternatively, the threaded shaft 60 is threadably received within the threaded bore 56. The nut 62 and washer are threaded onto shaft 60 to a desired position. A desired position may be determined by placing a yoke 64 onto the threaded shaft 60. A driver with a marker (not shown) is placed on the yoke 64 and rotating the nut 62 on the shaft until a desired position is reached. Preferably, with the threaded shaft, the height of the cradle 66 can be extended up to 36″ or more above the surface. The ability to adjust the height of the yoke means that deflections in the member being supported may be accommodated.

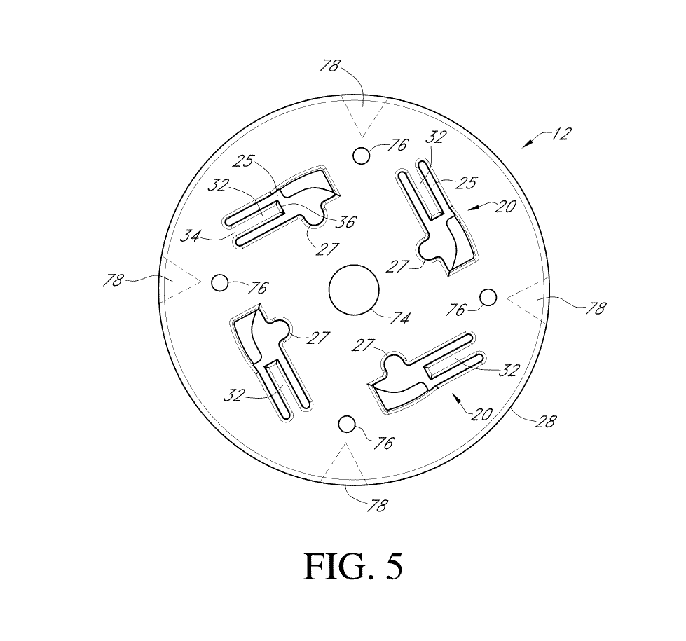

In another embodiment, as shown in FIG. 5, the base has a centrally located opening 74 and a plurality of mounting holes 76. The opening 74 permits adhesive, used to hold the base 12 in place, to come through the opening 70 so that other items (i.e., rebar chair) may be attached to the base.

The mounting holes 76 receive nails or screws to attach the base 12 to a hard surface. Also, in one example, the molded into the base 12 is a layer of mesh material that helps concrete and adhesive stick to the base 12. The mesh design also accepts concrete when patching is desired.

On the top surface 18 of the base 12, preferably around the outer periphery 28, are a plurality of notches or cutouts 78. The notches are used to align one assembly to another using a chalk line or the like.

As previously mentioned, the parts of the assembly 10 may be used singularly, or in various combinations. For example, any type of stand 14 can be used with or without a base 12, a yoke 16, a threaded shaft 60, a nut 62, or a washer 63. Likewise, the base 12 may be used with or without a stand 14, a yoke 16, a threaded shaft 60, a nut 62, or a washer 63. The stand 14 can hold a variety of structural elements such as rebar, dowels, and different size pipes.

Thus, a support assembly has been disclosed that at the very least, has met all the stated objectives.

What is claimed is:

1. A support assembly, comprising:
a base;
a stand removably connected to the base;
wherein the stand has a plurality of legs, a platform, and a support member.

2. The assembly of claim 1 further comprising a yoke removably attached to the stand.

3. The assembly of claim 1 wherein the base has a plurality of slots that receive the stand.

4. The assembly of claim 3 wherein the slots each have a flexible prong.

5. The assembly of claim 3 wherein the slots have an outer wall, a top wall, an end wall, and an open bottom having an arcuate section.

6. The assembly of claim 1 wherein the support member receives a threaded shaft and the threaded shaft receives a yoke.
